(19) United States
(12) Patent Application Publication
(10) Pub. No.: US 2023/0367331 A1
(43) Pub. Date: Nov. 16, 2023

(54) VEHICLE TRANSPORTATION DEVICE, VEHICLE TRANSPORTATION METHOD, AND PROGRAM

(71) Applicant: TOYOTA JIDOSHA KABUSHIKI KAISHA, Aichi-ken (JP)

(72) Inventors: Masayuki ITOH, Nagoya-shi (JP); Iwao MAEDA, Nagoya-shi (JP); Tatsuya SUGANO, Susono-shi (JP); Norinao WATANABE, Susono-shi (JP); Yutaka NAKAMURA, Susono-shi (JP); Yoshikazu JIKUHARA, Susono-shi (JP); Yuki NISHIKAWA, Susono-shi (JP)

(21) Appl. No.: 18/179,382

(22) Filed: Mar. 7, 2023

(30) Foreign Application Priority Data
May 12, 2022 (JP) 2022-079063

(51) Int. Cl. G05D 1/02; G05D 1/00; B60P 3/07

(52) U.S. Cl. CPC G05D 1/0276; G05D 1/0088; B60P 3/07; G05D 2201/0213

(57) ABSTRACT

The server receives the driving difficulty information indicating that the driving of the vehicle by the driver is difficult, determines that the current position of the vehicle is within a predetermined transportation target area, and, in response to receiving the driving difficulty information and determining that the current position of the vehicle is within the transportation target area, causes the transportation robot to convey the vehicle from the current position to a predetermined transportation destination.

### CROSS-REFERENCE TO RELATED APPLICATION

This application claims priority to Japanese Patent Application No. 2022-079063 filed on May 12, 2022, incorporated herein by reference in its entirety.

### BACKGROUND

### 1. Technical Field

The present disclosure relates to a vehicle transportation device, a vehicle transportation method, and a program.

### 2. Description of Related Art

A drunk driving prevention device is known in which traveling of a vehicle is prohibited when a driver is determined to be in a drinking state by detecting an alcohol concentration in exhaled breath of the driver (for example, see Japanese Unexamined Patent Application Publication No. 2008-184059 (JP 2008-184059 A)).

### SUMMARY

In JP 2008-184059 A, it is considered that a vehicle whose traveling is prohibited is located in, for example, a parking lot of a restaurant. Then, when the vehicle is prohibited from traveling, a section of the parking lot continues to be occupied by the vehicle until the driver recovers from the drinking state. This is undesirable for other drivers trying to park their vehicles in the parking lot. Moreover, this is also undesirable for the restaurant that owns the parking lot.

According to the present disclosure, the following are provided.

### Configuration 1

A vehicle transportation device includes:
a reception unit configured to receive driving difficulty information indicating that driving of a vehicle by a driver is difficult;
a determination unit configured to determine that a present position of the vehicle is within a predetermined transportation target area; and
a transportation unit configured to cause a transportation robot to transport the vehicle from the present position to a predetermined transportation destination in response to reception of the driving difficulty information by the reception unit and determination that the present position of the vehicle is within the transportation target area by the determination unit.

### Configuration 2

In the vehicle transportation device according to the configuration 1, the transportation unit is configured to cause the transportation robot to transport the vehicle in response to further reception of approval of the driver for transporting the vehicle.

### Configuration 3

In the vehicle transportation device according to the configurations 1 or 2, the transportation target area includes a parking lot available for a plurality of persons.

### Configuration 4

In the vehicle transportation device according to any one of the configurations 1 to 3, the vehicle is a vehicle configured such that the driving is restricted when the driving difficulty information is transmitted.

### Configuration 5

A vehicle transportation method includes:
receiving driving difficulty information indicating that driving of a vehicle by a driver is difficult;
determining that a present position of the vehicle is within a predetermined transportation target area; and
causing a transportation robot to transport the vehicle from the present position to a predetermined transportation destination in response to reception of the driving difficulty information and determination that the present position of the vehicle is within the transportation target area.

### Configuration 6

A program includes:
receiving driving difficulty information indicating that driving of a vehicle by a driver is difficult;
determining that a present position of the vehicle is within a predetermined transportation target area; and
causing a transportation robot to transport the vehicle from the present position to a predetermined transportation destination in response to reception of the driving difficulty information and determination that the present position of the vehicle is within the transportation target area.

It is possible to restrict the vehicle from staying in the transportation target area.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic overview of a vehicle transport system according to an embodiment of the present disclosure;

FIG. 2 is a schematic view of a vehicle according to an embodiment of the present disclosure;

FIG. 3 is a schematic diagram of a server of an embodiment according to the present disclosure;

FIG. 4 is a schematic diagram of a transportation robot according to an embodiment of the present disclosure;

FIG. 5A is a side view of a transportation robot of an embodiment in accordance with the present disclosure showing a state in which a carriage is in a lowered position and an arm is in a retracted position;

FIG. 5B is a schematic view of a transportation robot according to an embodiment of the present disclosure showing a state in which the carriage is in a lowered position and the arm is in a retracted position;

FIG. 6A is a side view of a transportation robot of an embodiment in accordance with the present disclosure showing a state in which a carriage is in a raised position and an arm is in a deployed position;

FIG. 6B is a schematic view of a transportation robot according to an embodiment of the present disclosure showing a state in which the carriage is in a raised position and the arm is in a deployed position;

FIG. 7 is a diagram illustrating a vehicle transport method according to an embodiment of the present disclosure;

FIG. 8 is a diagram illustrating a vehicle transport method according to an embodiment of the present disclosure;

FIG. 9 is a flowchart illustrating a vehicle transport control routine according to an embodiment of the present disclosure;

FIG. 10 is a functional block diagram of a processor of a server according to an embodiment of the present disclosure;

FIG. 11 is a diagram illustrating another embodiment of a vehicle-transporting system according to the present disclosure; and

FIG. 12 is a flowchart illustrating a vehicle transport control routine according to another embodiment of the present disclosure.

### DETAILED DESCRIPTION OF EMBODIMENTS

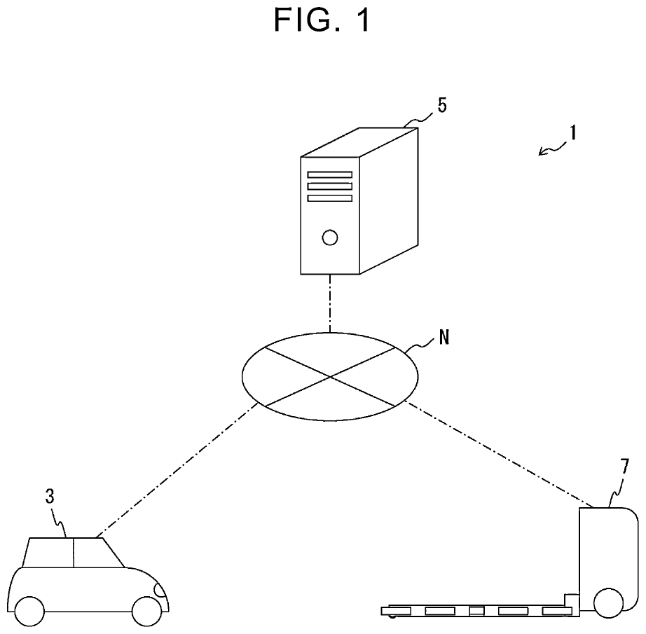

FIG. 1 schematically shows a vehicle transport system 1 according to an embodiment of the present disclosure. As shown in FIG. 1, the vehicle transport system 1 includes a manual driving vehicle 3, a server 5, and a transportation robot 7. The vehicle 3, the server 5, and the transportation robot 7 are communicably connected to a communication network N such as the Internet. In the vehicle transport system 1 according to the embodiment of the present disclosure, the vehicle 3 is transported by the transportation robot 7 for automated driving.

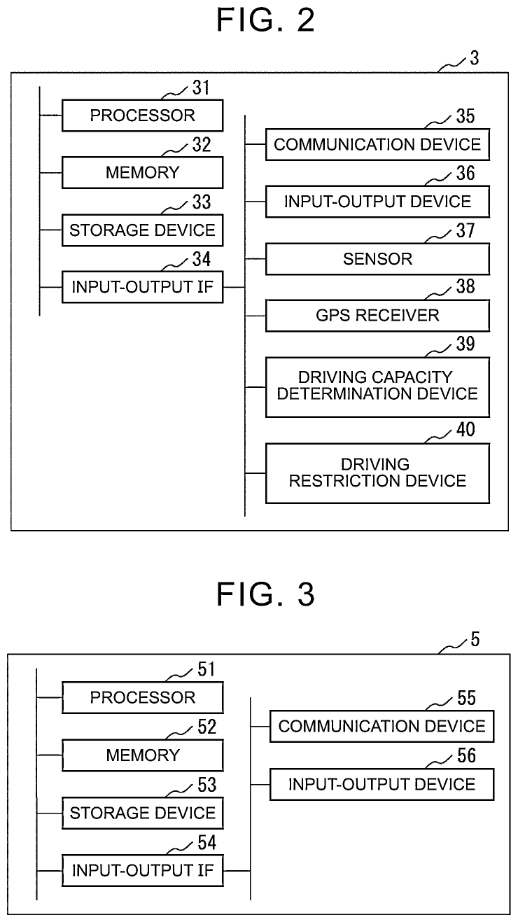

The vehicle 3 according to the disclosed embodiment comprises one or more processors 31, one or more memories 32, a storage device 33, and an input/output interface (IF) 34, as shown schematically in FIG. 2. The processor 31, the memory 32, the storage device 33, and the input/output IF 34 are communicably connected to each other by bi-directional buses. The memory 32 includes a volatile or non-volatile memory. Various programs and the like are stored in the memory 32. These programs are executed by the processor 31. The storage device 33 stores map data, a calculation model, and the like. A communication device 35, an input/output device 36, one or more sensors 37, a GPS receiver 38, a driving capability determination device 39, a driving restriction device 40, and the like are communicably connected to the input/output IF 34.

The communication device 35 is communicably connected to the communication network N. The input/output device 36 includes, for example, a HMI (a display with a touch panel, a speaker, and the like), a keyboard, a mouse, a media reader/writer, and the like. The sensor 37 detects data for driving the vehicle 3. GPS receiver 38 detects the absolute position (e.g., longitude and latitude) of the vehicle 3 by receiving signals from GPS satellites.

The driving capability determination device 39 determines whether or not it is difficult for the driver to drive the vehicle 3. In an example, the driving capability determination device 39 includes a sensor that detects the concentration of alcohol in the exhaled breath of the driver. When the breath alcohol concentration of the driver exceeds the upper limit value, the driving capability determination device 39 determines that driving of the vehicle 3 by the driver is difficult. When the alcohol concentration in the exhaled breath of the driver does not exceed the upper limit value, the driving capability determination device 39 does not determine that the driver is difficult to drive the vehicle. In another example, the driving capability determination device 39 alternatively or additionally comprises a camera for capturing a driver. The driving capability determination device 39 determines whether or not it is difficult for the driver to drive the vehicle 3 based on the behavior of the driver or the like. In an example, when it is determined from the behavior of the driver that the driver has sleepiness, fatigue, pain, or the like, the driving capability determination device 39 determines that driving of the vehicle 3 by the driver is difficult.

When the driving capability determination device 39 determines that driving of the vehicle 3 by the driver is difficult, the driving restriction device 40 restricts the driving of the vehicle 3. In one example, the engine or electric motor continues to be stopped. In another example, the brake continues to be activated. On the other hand, when the driving capability determination device 39 does not determine that the driving of the vehicle 3 by the driver is difficult, the driving of the vehicle 3 is permitted.

On the other hand, the server 5 of the embodiment according to the present disclosure includes one or more processors 51, one or more memories 52, a storage device 53, and an input/output interface (IF) 54, as schematically illustrated in FIG. 3. The processor 51, the memory 52, the storage device 53, and the input/output IF 54 are communicably connected to each other by a bi-directional bus. The memory 52 includes volatile or non-volatile memory. The memory 52 stores various programs and the like. These programs are executed by the processor 51. The storage device 53 stores map data, a calculation model, and the like. A communication device 55, an input/output device 56, and the like are communicably connected to the input/output IF 54. The communication device 55 is communicatively connected to the communication network N. The input/output device 56 includes, for example, a HMI (a display with a touch panel, a speaker, and the like), a keyboard, a mouse, a media reader/writer, and the like. The limiting member control device 57 is communicably connected to an actuator 43, which will be described later.

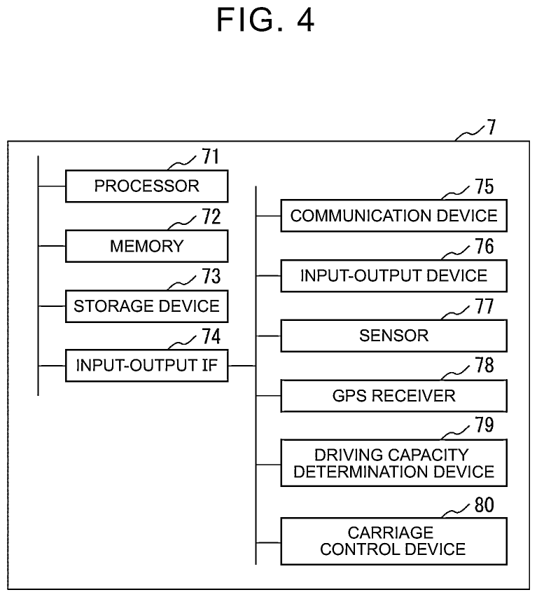

A transportation robot 7 according to an embodiment of the present disclosure includes one or more processors 71, one or more memories 72, a storage device 73, and an input/output interface (IF) 74, as schematically illustrated in FIG. 4. The processor 71, the memory 72, the storage device 73, and the input/output IF 74 are communicably connected to each other by bi-directional buses. The memory 72 includes volatile or non-volatile memory. The memory 72 stores various programs and the like. These programs are executed by the processor 71. The storage device 73 stores map data, a calculation model, and the like. A communication device 75, an input/output device 76, one or more sensors 77, a GPS receiver 78, an autonomous driving device 79, a carriage control device 80, and the like are communicably connected to the input/output IF 74.

The communication device 75 is communicably connected to the communication network N. The input/output device 76 includes, for example, a HMI (a display with a touch panel, a speaker, and the like), a keyboard/mouse, a media reader/writer, and the like. The sensor 77 detects data for driving the transportation robot 7. GPS receiver 78 detects the absolute position (e.g., longitude and latitude) of the transportation robot 7 by receiving signals from GPS satellites. The autonomous driving device 79 includes an environment sensor for recognizing the surrounding environment of the transportation robot 7, and an actuator for driving, steering, and braking the transportation robot 7. The environmental sensor includes, for example, a camera, a LiDAR, or the like that photographs the periphery of the transportation robot 7. The carriage control device 80 will be described later.

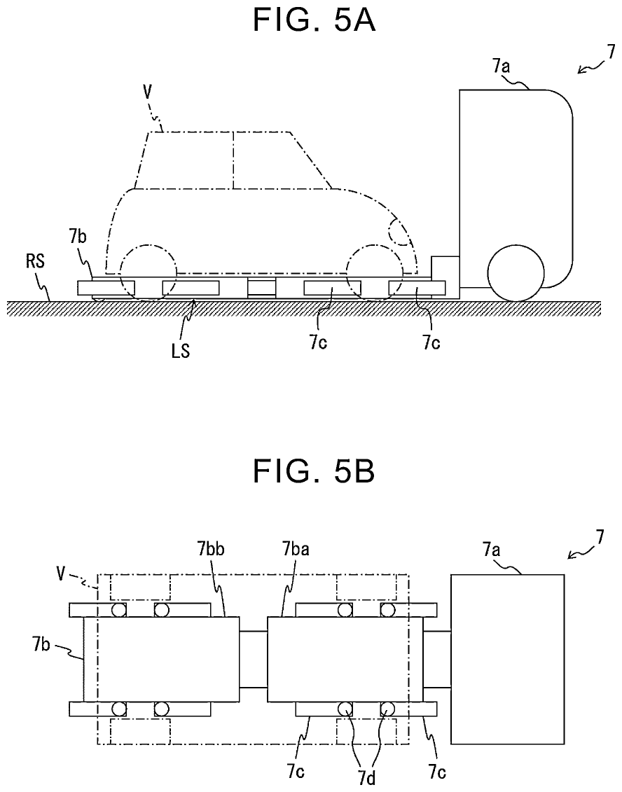

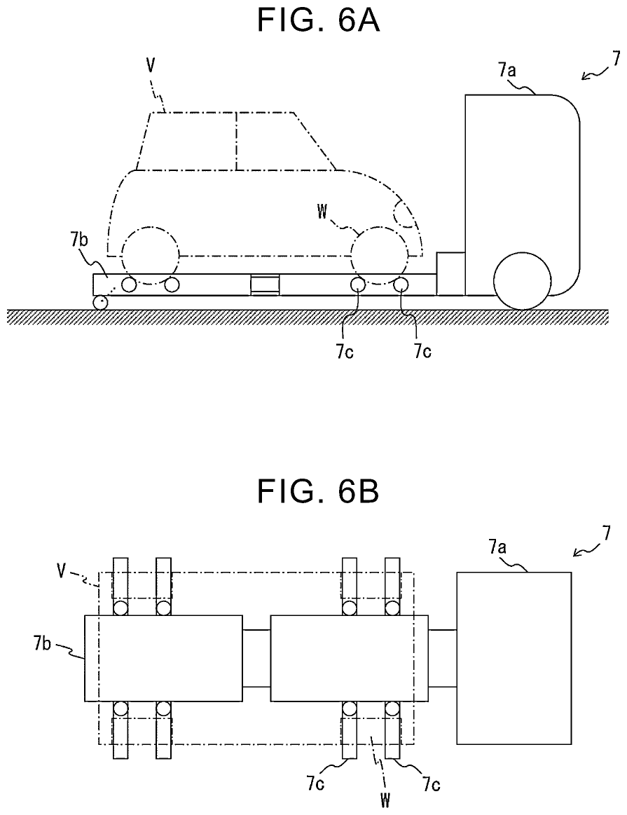

FIGS. 5A, 5B, 6A, and 6B diagrammatically shows an embodiment of a transportation robot 7 according to the present disclosure. As shown in FIGS. 5A, 5B, 6A, and 6B, the transportation robots 7 comprise a drive part 7a and a carriage 7b connected to each other while being longitudinally aligned. The drive part 7a is a battery electric vehicle (BEV equipped with the above-mentioned autonomous driving device 79). The carriage 7b is vertically movable between a relatively low lowered position and a relatively high raised position by the carriage control device 80 described above. In FIGS. 5A and 5B, the carriage 7b is in a lowered position. On the other hand, in FIGS. 6A and 6B, the carriage 7b is in the raised position. The carriage 7b also includes a pair of longitudinally aligned carriage part 7ba, 7bb. These carriage part 7ba, 7bb are longitudinally movable relative to each other by the above-described carriage control device 80. A pair of arm 7c are longitudinally spaced apart from each other and attached to each side portion of each carriage part 7ba, 7bb on the carriage part 7ba, 7bb. The arm 7c is movable about the pinning 7d, 7d between the retracted position and the deployed position by the carriage control device 80 described above. The retracted position is a position extending longitudinally along the carriage part 7ba, 7bb. The deployed position is a position extending in a direction perpendicular to the longitudinal direction away from the carriage part 7ba, 7bb. In FIGS. 5A and 5B, the arm 7c is in the retracted position. On the other hand, in FIGS. 6A and 6B, the arm 7c is in the deployed position.

When the transportation robot 7 is to transfer the vehicle V, the transportation robot 7 moves to the vehicle V while the carriage 7b is in the lowered position and the arm 7c is in the retracted position. Next, as shown in FIGS. 5A and 5B, the transportation robots 7 are moved so that the carriage 7b enters the lower space LS formed between the vehicles V and the road surface RS. In one example, the carriage 7b enters into the lower space LS from one longitudinal end of the lower space LS. At this time, the position of the carriage 7b with respect to the vehicle V and the longitudinal relative position of the carriage part 7ba, 7bb are controlled so that the arm 7c face the respective tires W. The arm 7c is then moved to the deployed position. Consequently, the arm 7c is located below the tire W on the front side and the rear side of the corresponding tire W. The carriage 7b is then moved to the raised position. As a consequence, the vehicles V are lifted by the transportation robots 7, as shown in FIGS. 6A and 6B. The transportation robot 7 moves the vehicle V in a state of lifting the vehicle V, and thereby conveys the vehicle V.

Then, when the transportation robot 7 reaches the target position, the carriage 7b is moved to the lowered position. The arm 7c is then moved to the retracted position. Next, the transportation robots 7 are moved so that the carriage 7b exits from the lower space LS. In this way, the vehicle V is unloaded from the transportation robot 7.

The transportation robot 7 or the carriage 7b may enter the lower space LS from the front side of the vehicle V or may enter the lower space LS from the rear side of the vehicle V.

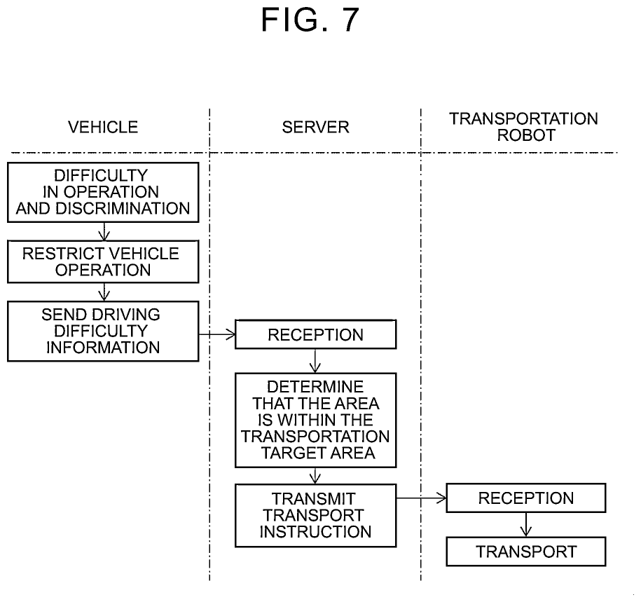

Referring now to FIG. 7, a vehicle transport method according to an embodiment of the present disclosure will be described. When the driver gets into the parked vehicle 3, the driving capability determination device 39 determines whether it is difficult for the driver to drive the vehicle 3. When it is determined that the driver is difficult to drive the vehicle, the driving restriction device 40 restricts the driving of the vehicle 3. Further, the vehicle 3 transmits the driving difficulty information to the server 5. The driving difficulty information indicates that it is difficult for the driver to drive the vehicle 3. Further, the driving difficulty information includes position information indicating the present position of the vehicle 3 and a driver or a user ID for identifying the vehicle 3.

Upon receiving the driving difficulty information, the server 5 determines whether or not the current position of the vehicle 3 is within a predetermined transportation target area. The transportation target area of the embodiment according to the present disclosure is, for example, an area in which it is not preferable for the vehicle to stay. In one example, the transportation target area is a parking lot used by a plurality of persons, such as a parking lot of a store, a restaurant, a hospital, a station, or the like. The position information of the transportation target area is stored in advance in the storage device 53 of the server 5.

When it is determined that the vehicle 3 is located in the transportation target area, a conveyance instruction is transmitted from the server 5 to the transportation robot 7. The conveyance instruction of the embodiment according to the present disclosure includes the current position information, the transportation destination information, the conveyance route, and the like of the vehicle 3. The transportation robot 7 that has received the transfer instruction, for example, moves from the standby place to the current position of the vehicle 3. The transportation robot 7 lifts the vehicle 3. Next, the transportation robot 7 moves toward the transportation destination while transferring the vehicle 3. Upon reaching the transportation destination, the transportation robot 7 lowers the vehicle 3. In this way, the vehicle 3 is conveyed to the transportation destination. In other words, the vehicle 3 is removed from the transportation target area. The driver is conveyed to the transportation destination by continuing to ride in the vehicle 3. The transportation robot 7 is then moved back to the standby or to another vehicle to be transported.

On the other hand, when it is determined that the vehicle 3 is located outside the transportation target area, a conveyance instruction is transmitted from the server 5 to the transportation robot 7. As a result, the vehicle 3 is allowed to remain in the current position.

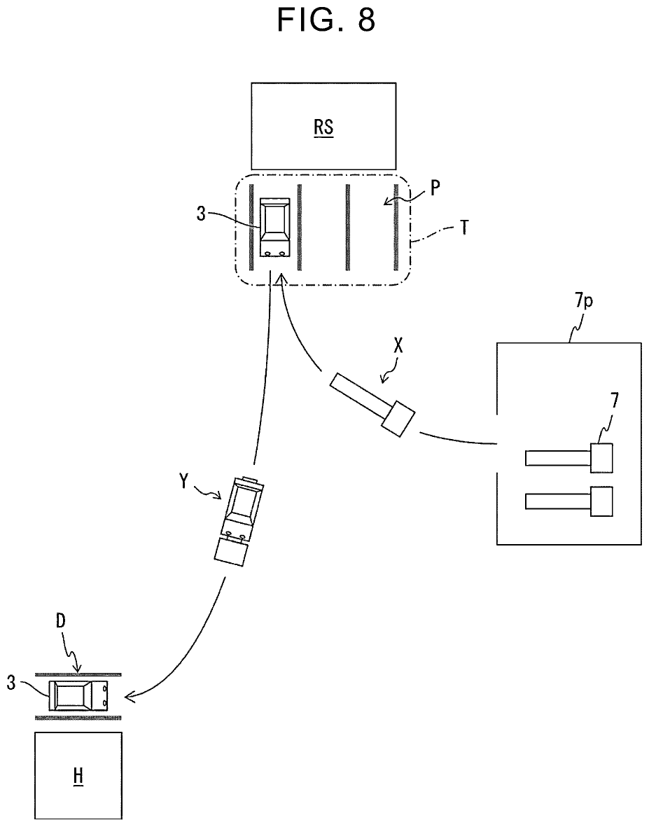

In the embodiment shown in FIG. 8, the vehicles 3 are parked in a parking lot P of a restaurant RS. The parking lot P is located in the transportation target area T. Therefore, when it is determined that driving of the vehicle 3 by the driver is difficult, the transportation robot 7 is directed from the standby place 7p to the parking lot P (X in FIG. 8). Next, the transportation robot 7 transfers the vehicle 3 to the transportation destination D (Y in FIG. 8). In the example illustrated in FIG. 8, the transportation destination D is a parking space of the home H.

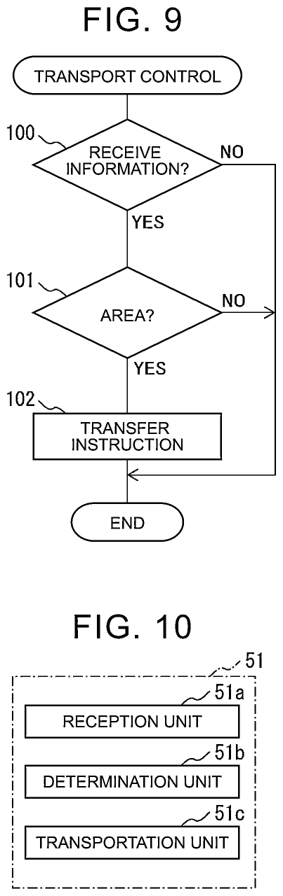

FIG. 9 illustrates a vehicle transport control routine in an embodiment in accordance with the present disclosure. This routine is repeatedly executed by the processor 51 of the server 5, for example. As illustrated in FIG. 9, in step 100, it is determined whether or not the server 5 has received the driving difficulty information. If it is determined that the server 5 has received the driving difficulty information, the process then proceeds to step 101. In step 101, it is determined whether or not the vehicle 3 is located in the transportation target area. When it is determined that the vehicle 3 is located in the transportation target area, the process then proceeds to step 102. In step 102, a transfer instruction is transmitted to the transportation robot 7. Therefore, it is restricted that the vehicle 3 remains at the current position. When it is not determined in step 100 that the server 5 has received the driving difficulty information, or when it is not determined in step 102 that the vehicle 3 is located in the transportation target area, the processing cycle ends. That is, the vehicle 3 is allowed to remain at the current position.

FIG. 10 shows a functional block diagram of a processor 51 of a server 5 according to an embodiment of the present disclosure. Referring to FIG. 10, the processor 51 includes a reception unit 51a, a determination unit 51b, and a transportation unit 51c. The reception unit 51a is configured to receive driving difficulty information indicating that driving of the vehicle by the driver is difficult. The determination unit 51b is configured to determine whether the present position of the vehicle is within a predetermined transportation target area. In response to the reception unit 51a receiving the driving difficulty information and the determination unit 51b determining that the current position of the vehicle is within the transportation target area, the transportation unit 51c is configured to cause the transportation robot to convey the vehicle from the current position to a predetermined transportation destination.

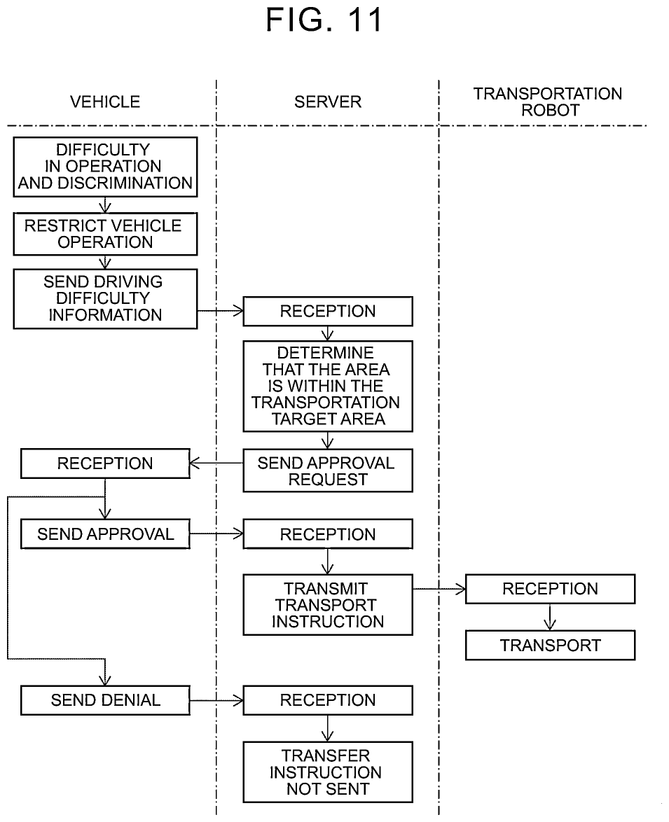

FIG. 11 illustrates another embodiment according to the present disclosure. Differences between the embodiment shown in FIG. 7 and the embodiment shown in FIG. 11 will be described. In the example illustrated in FIG. 11, when it is determined that the vehicle 3 is located in the transportation target area, an approval request is transmitted from the server 5 to the vehicle 3. The destination data is stored in advance in the servers 5 in association with the user ID. When the driver approves the transportation of the vehicle 3 by the transportation robot 7, the driver responds to the server 5 with the approval. Next, when the approval is received by the server 5, the transfer instruction is transmitted from the server 5 to the transportation robot 7. On the other hand, if the driver does not approve the transport, the driver answers to the server 5 for disapproval. Next, when the denial is received by the server 5, the transfer instruction from the server 5 to the transportation robot 7 is not transmitted. In this way, for example, when the driving capability determination device 39 erroneously determines, unnecessary vehicle conveyance by the transportation robot 7 is restricted.

Note that the authorization request and the answer thereof are transmitted and received via HMI of the vehicles 3. In another example, the authorization request and the answer are sent and received via the mobile terminal of the driver.

In another embodiment, the transportation destination of the vehicles 3 is stored in advance in the servers 5 in association with the user ID. In another example, the destination of the vehicle 3 is transmitted to the server 5 together with the approval. In this way, it is not necessary to store the transportation destination in the server 5 in advance.

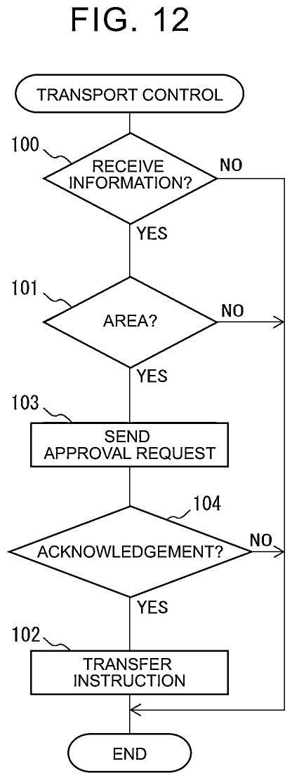

FIG. 12 illustrates a vehicle transport control routine in another embodiment in accordance with the present disclosure. Differences between the routine of FIG. 9 and the routine of FIG. 12 will be described. When it is determined in step 101 that the vehicle 3 is located in the transportation target area, the process then proceeds to step 103. In step 103, an authorization request is sent from the server 5. In the following step 104, it is determined whether the server 5 has received the approval. If it is determined that the server 5 has received the authorization, the process then proceeds to step 102. On the other hand, when it is not determined that the server 5 has received the approval, the processing cycle ends.

In the above-described embodiment, the current position information of the vehicle 3 is included in the driving difficulty information, and the current position information of the vehicle 3 is transmitted from the vehicle 3. In another case, when the driving difficulty information including the user ID is received by the server 5, the present position of the vehicle 3 associated with the user ID is searched, for example, by using a camera installed in a parking lot or a street. In one embodiment, information representing the vehicle 3 (e.g., vehicle number, vehicle type, color, etc.) in association with the user ID is stored in advance in the servers 5. Based on the information and the image of the camera, the position of the vehicle 3 to be transported is identified. When the position of the vehicle 3 is identified, the position information is transmitted to the server 5.

In the above-described embodiment, the driving capability determination device 39 is provided in the vehicle 3. In another example, the driving capability determination device 39 is provided outside the vehicle 3, for example, in a parking facility including a camera. In this other example, it is determined whether it is difficult for the driver to drive the vehicle 3 on the basis of the behavior of the driver until getting into the vehicle 3, which is captured by the camera installed in the parking lot. When it is determined that driving of the vehicle 3 by the driver is difficult, the driving difficulty information is transmitted from the parking lot facility to the server 5. The position information of the vehicle 3 to be transported is also specified based on the camera image, and is transmitted from the parking facility to the server 5.

What is claimed is:

1. A vehicle transportation device comprising:
a reception unit configured to receive driving difficulty information indicating that driving of a vehicle by a driver is difficult;
a determination unit configured to determine that a present position of the vehicle is within a predetermined transportation target area; and
a transportation unit configured to cause a transportation robot to transport the vehicle from the present position to a predetermined transportation destination in response to reception of the driving difficulty information by the reception unit and determination that the present position of the vehicle is within the transportation target area by the determination unit.

2. The vehicle transportation device according to claim 1, wherein the transportation unit is configured to cause the transportation robot to transport the vehicle in response to further reception of approval of the driver for transporting the vehicle.

3. The vehicle transportation device according to claim 1, wherein the transportation target area includes a parking lot available for a plurality of persons.

4. The vehicle transportation device according to claim 1, wherein the vehicle is a vehicle configured such that the driving is restricted when the driving difficulty information is transmitted.

5. A vehicle transportation method comprising:
receiving driving difficulty information indicating that driving of a vehicle by a driver is difficult;
determining that a present position of the vehicle is within a predetermined transportation target area; and
causing a transportation robot to transport the vehicle from the present position to a predetermined transportation destination in response to reception of the driving difficulty information and determination that the present position of the vehicle is within the transportation target area.

6. A program comprising:
receiving driving difficulty information indicating that driving of a vehicle by a driver is difficult;
determining that a present position of the vehicle is within a predetermined transportation target area; and
causing a transportation robot to transport the vehicle from the present position to a predetermined transportation destination in response to reception of the driving difficulty information and determination that the present position of the vehicle is within the transportation target area.
